(19) United States
(12) Patent Application Publication
(10) Pub. No.: US 2003/0093253 A1
(43) Pub. Date: May 15, 2003

(54) Grammar for message passing in a distributed simulation environment

(76) Inventors: James P. Freyensee, Los Altos, CA (US); Carl B. Frankel, San Francisco, CA (US); Steven A. Sivier, Fremont, CA (US); Carl Cavanagh, Oakland, CA (US)

Correspondence Address: Lawrence J. Merkel, Conley, Rose & Tayon, P.C., P.O. Box 398, Austin, TX, 78767-0398, US

(21) Appl. No.: 10/008,155

(22) Filed: Nov. 9, 2001

(51) Int. Cl. G06G 7/62

(52) U.S. Cl. 703/13

(57) ABSTRACT

A distributed simulation system includes a plurality of nodes and a hub. Each node may simulate a portion of a system under test, or may execute a test program for the simulation. The hub may route message packets from one node to another. The message packets are formatted according to a grammar used by the distributed simulation system, which abstracts the physical signals of the system under test to logical ports. Additionally, some embodiments may include other commands, such as commands for configuring the distributed simulation system, describing the logical ports and logical signals within the logical ports, and mapping the logical signals to physical signals. A formatter program may be used in each node and the hub to format message packets for transmission, according to the grammar. A parser program may be used in each node and the hub to parse received message packets, again according to the grammar.

### BACKGROUND OF THE INVENTION

1. Field of the Invention

This invention is related to the field of distributed simulation systems and, more particularly, to communication between nodes in a distributed simulation system.

2. Description of the Related Art

Generally, the development of components for an electronic system such as a computer system includes simulation of models of the components. In the simulation, the specified functions of each component may be tested and, when incorrect operation (a bug) is detected, the model of the component may be changed to generate correct operation. Once simulation testing is complete, the model may be fabricated to produce the corresponding component. Since many of the bugs may have been detected in simulation, the component may be more likely to operate as specified and the number of revisions to hardware may be reduced. The models are frequently described in a hardware description language (HDL) such as Verilog, VHDL, etc. The HDL model may be simulated in a simulator designed for the HDL, and may also be synthesized, in some cases, to produce a netlist and ultimately a mask set for fabricating an integrated circuit.

Originally, simulations of electronic systems were performed on a single computing system. However, as the electronic systems (and the components forming systems) have grown larger and more complex, single-system simulation has become less desirable. The speed of the simulation (in cycles of the electronic system per second) may be reduced due to the larger number of gates in the model which require evaluation. Additionally, the speed may be reduced as the size of the electronic system model and the computer code to perform the simulation may exceed the memory capacity of the single system. In some cases, the simulators may not be capable of simulating the entire model. As the speed of the simulation decreases, simulation throughput is reduced.

To address some of these issues, distributed simulation has become more common. Generally, a distributed simulation system includes two or more computer systems simulating portions of the electronic system in parallel. Each computer system must communicate with other computer systems simulating portions of the electronic system to which the portion being simulated on that computer system communicates, to pass signal values of the signals which communicate between the portions.

Typically, distributed simulation systems have performed the above mentioned communication from a hardware point of view. That is, the distributed simulation system passes the logical state of each signal (binary one, binary zero, “Z” for high impedance, and “X” for no state being driven). Generally, the passing of values does not include signal strength information or other high level communication between the nodes (e.g. command/control information for the simulation).

### SUMMARY OF THE INVENTION

A distributed simulation system includes a plurality of nodes and optionally a hub. Each node may simulate a portion of a system under test. The hub may route message packets from one node to another (or the nodes may be coupled to transmit the message packets from one node to another). The message packets are formatted according to a grammar used by the distributed simulation system, which abstracts the physical signals of the system under test to logical ports. Additionally, some embodiments may include other commands, such as commands for configuring the distributed simulation system, describing the logical ports and logical signals within the logical ports, and mapping the logical signals to physical signals. Other commands may be included in other embodiments, as desired.

The grammar may be used, in an embodiment, as a common API for the nodes and the hub. The grammar may also provide, in some embodiments, human readable message packets. A formatter program may be used in each node and the hub to format message packets for transmission, according to the grammar. A parser program may be used in each node and the hub to parse received message packets, again according to the grammar.

### BRIEF DESCRIPTION OF THE DRAWINGS

The following detailed description makes reference to the accompanying drawings, which are now briefly described.

FIG. 1 is a block diagram of one embodiment of a distributed simulation system.

FIG. 2 is a block diagram illustrating logical ports in an exemplary distributed simulation.

FIG. 3 is a block diagram of one embodiment of a distributed simulation node.

FIG. 4 is a block diagram of one embodiment of a distributed control node.

FIG. 5 is a block diagram of one embodiment of a hub.

FIG. 6 is a flowchart illustrating operation of one embodiment of a parser program shown in FIGS. 3, 4, and 5.

FIG. 7 is a flowchart illustrating operation of one embodiment of a formatter program shown in FIGS. 3, 4, and 5.

FIG. 8 is a block diagram of one embodiment of a message packet.

FIG. 9 is a table illustrating exemplary commands.

FIG. 10 is a definition, in Backus-Naur Form (BNF), of one embodiment of a POV command.

FIG. 11 is a definition, in BNF, of one embodiment of an SCF command.

FIG. 12 is a definition, in BNF, of one embodiment of a DDF command.

FIG. 13 is an example distributed simulation system.

FIG. 14 is an example POV command for the system shown in FIG. 13.

FIG. 15 is an example SCF command for the system shown in FIG. 13.

FIG. 16 is an example DDF command for the chip1 element shown in FIG. 13.

FIG. 17 is an example DDF command for the chip2 element shown in FIG. 13.

FIG. 18 is an example DDF command for the rst_ctl element shown in FIG. 13.

FIG. 19 is a block diagram of a carrier medium storing the parser program shown in FIG. 6 and the formatter program shown in FIG. 7.

FIG. 20 is a block diagram of an exemplary data structure which may be used by one embodiment of the parser program.

FIG. 21 is a block diagram of an exemplary data structure which may be used by one embodiment of the formatter program.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Distributed Simulation System Overview

In the discussion below, both the computer systems comprising the distributed simulation system (that is, the computer systems on which the simulation is being executed) and the electronic system being simulated are referred to. Generally, the electronic system being simulated will be referred to as the “system under test”.

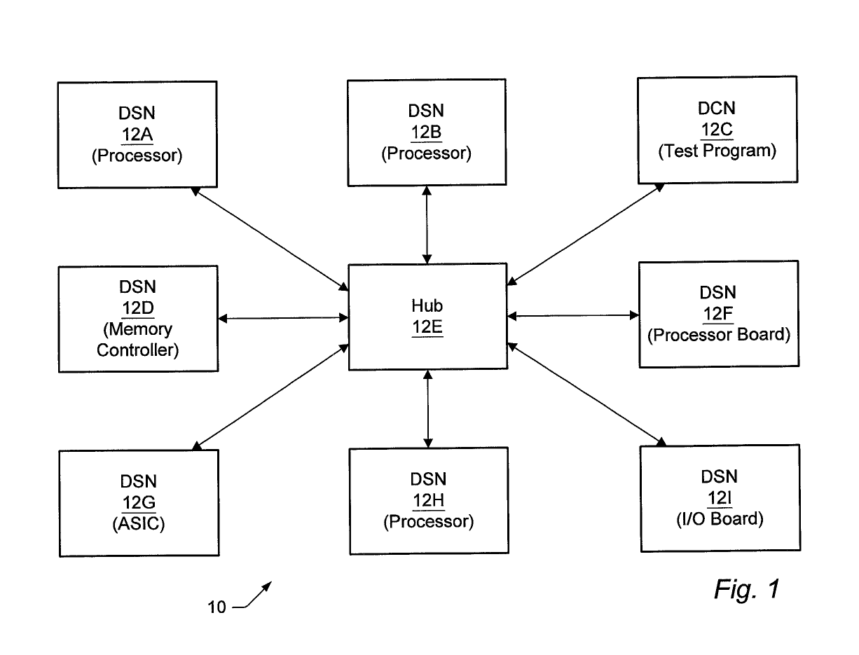

Turning now to FIG. 1, a block diagram of one embodiment of a distributed simulation system 10 is shown. Other embodiments are possible and contemplated. In the embodiment of FIG. 1, the system 10 includes a plurality of nodes 12A-12I. Each node 12A-12D and 12F-12I is coupled to communicate with at least node 12E (which is the hub of the distributed simulation system). Nodes 12A-12B, 12D, and 12F-121 are distributed simulation nodes (DSNs), while node 12C is a distributed control node (DCN).

Generally, a node is the hardware and software resources for: (i) simulating a component of the system under test; or (ii) running a test program or other code (e.g. the hub) for controlling or monitoring the simulation. A node may include one or more of: a computer system (e.g. a server or a desktop computer system), one or more processors within a computer system (and some amount of system memory allocated to the one or more processors) where other processors within the computer system may be used as another node or for some other purpose, etc. The interconnection between the nodes illustrated in FIG. 1 may therefore be a logical interconnection. For example, in one implementation, Unix sockets are created between the nodes for communication. Other embodiments may use other logical interconnection (e.g. remote procedure calls, defined application programming interfaces (APIs), shared memory, pipes, etc.). The physical interconnection between the nodes may vary. For example, the computer systems including the nodes may be networked using any network topology. Nodes operating on the same computer system may physically be interconnected according to the design of that computer system.

A DSN is a node which is simulating a component of the system under test. A component may be any portion of the system under test. For example, the embodiment illustrated in FIG. 1 may be simulating a computer system, and thus the DSNs may be simulating processors (e.g. nodes 12A-12B and 12H), a processor board on which one or more of the processors may physically be mounted in the system under test (e.g. node 12F), an input/output (I/O) board comprising input/output devices (e.g. node 12I), an application specific integrated circuit (ASIC) which may be mounted on a processor board, a main board of the system under test, the I/O board, etc. (e.g. node 12G), a memory controller which may also be mounted on a processor board, a main board of the system under test, the I/O board, etc. (e.g. node 12D).

Depending on the configuration of the system under test, various DSNs may communicate. For example, if the processor being simulated on DSN 12A is mounted on the processor board being simulated on DSN 12F in the system under test, then input/output signals of the processor may be connected to output/input signals of the board. If the processor drives a signal on the board, then a communication between DSN 12A and DSN 12F may be used to provide the signal value being driven (and optionally a strength of the signal, in some embodiments). Additionally, if the processor being simulated on DSN 12A communicates with the memory controller being simulated on DSN 12D, then DSNs 12A and 12D may communicate signal values/strengths.

A DCN is a node which is executing a test program or other code which is not part of the system under test, but instead is used to control the simulation, introduce some test value or values into the system under test (e.g. injecting an error on a signal), monitor the simulation for certain expected results or to log the simulation results, etc.

A DCN may communicate with a DSN to provide a test value, to request a value of a physical signal or other hardware modeled in the component simulated in the DSN, to communicate commands to the simulator in the DSN to control the simulation, etc.

The hub (e.g. node 12E in FIG. 1) is provided for routing communications between the various other nodes in the distributed simulation system. Each DSN or DCN transmits message packets to the hub, which parses the message packets and forwards message packets to the destination node or nodes for the message. Additionally, the hub may be the destination for some message packets (e.g. for synchronizing the simulation across the multiple DSNs and DCNs).

As mentioned above, the communication between the nodes 12A- 12I may be in the form of message packets. The format and interpretation of the message packets is specified by a grammar implemented by the nodes 12A-12I. The grammar is a language comprising predefined commands for communicating between nodes, providing for command/control message packets for the simulation as well as message packets transmitting signal values (and optionally signal strength information). Message packets transmitting signal values are referred to as signal transmission message packets, and the command in the message packet is referred to as a transmit command. The grammar may allow for more abstract communication between the nodes, allowing for the communication to be more human-readable than the communication of only physical signals and values of those signals between the nodes. As used herein, a physical signal is a signal defined in the simulation model of a given component of the system under test (e.g. an HDL model or some other type of model used to represent the given component). A logical signal is a signal defined using the grammar. Logical signals are mapped to physical signals using one or more grammar commands.

The grammar may include one or more commands for defining the configuration of the system under test. In one embodiment, these commands include a port of view (POV) command, a device description file (DDF) command, and a system configuration file (SCF) command. These commands may, in one implementation, be stored as files rather than message packets transmitted between nodes in the distributed simulation system. However, these commands are part of the grammar and may be transmitted as message packets if desired.

The POV command defines the logical port types for the system under test. Generally, signal information (which includes at least a signal value, and may optionally include a strength for the signal) is transmitted through a logical port in a message packet. That is, a message packet which is transmitting signal information transmits the signal information for one or more logical ports of a port type defined in the POV command. Accordingly, the POV command specifies the format of the signal transmission message packets. Generally, a logical port is an abstract representation of one or more physical signals. For example, the set of signals which comprises a particular interface (e.g. a predefined bus interface, a test interface, etc.) may be grouped together into a logical port. Transmitting a set of values grouped as a logical port may more easily indicate to a user that a communication is occurring on the particular interface than if the physical signals are transmitted with values.

In one embodiment, the logical ports may be hierarchical in nature. In other words, a given logical port may contain other logical ports. Accordingly, multiple levels of abstraction may be defined, as desired. For example, a bus interface which is pipelined, such that signals are used at different phases in a transaction on the bus interface (e.g. arbitration phase, address phase, response phase, etc.) may be grouped into logical ports for each phase, and the logical ports for the phases may be grouped into a higher level logical port for the bus as a whole. Specifically, in one embodiment, a logical port comprises at least one logical port or logical signal, and may comprise zero or more logical ports and zero or more logical signals in general. Both the logical ports and the logical signals are defined in the POV command. It is noted that the term “port” may be used below instead of “logical port”. The term “port” is intended to mean logical port in such contexts.

The DDF command is used to map logical signals (defined in the POV command) to the physical signals which appear in the models of the components of the system under test. In one embodiment, there may be at least one DDF command for each component in the system under test.

The SCF command is used to instantiate the components of the system under test and to connect logical ports of the components of the system under test. The SCF command may be used by the hub for routing signal transmission message packets from one node to another.

In addition to the above mentioned commands, the grammar may include a variety of other commands. For example, commands to control the start, stop, and progress of the simulation may be included in the grammar. An exemplary command set is shown in more detail below.

While the embodiment shown in FIG. 1 includes a node operating as a hub (node 12E), other embodiments may not employ a hub. For example, DSNs and DCNs may each be coupled to the others to directly send commands to each other. Alternatively, a daisy chain or ring connection between nodes may be used (where a command from one node to another may pass through the nodes coupled therebetween). In some embodiments including a hub, the hub may comprise multiple nodes. Each hub node may be coupled to one or more DSN/DCNs and one or more other hub nodes (e.g. in a star configuration among the hub nodes). In some embodiments, a DCN or DSN may comprise multiple nodes.

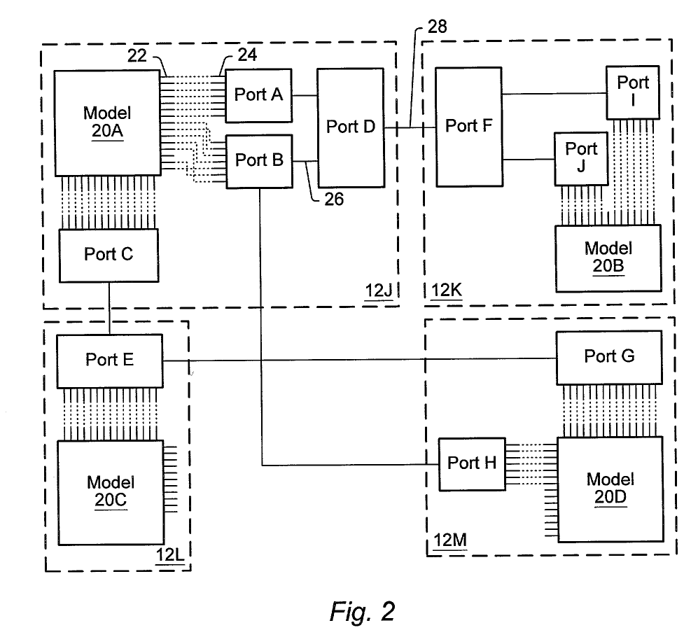

Turning next to FIG. 2, a block diagram illustrating the use of logical signals and logical ports in an exemplary system under test which includes four models is shown. Each model may be in a different node 12J-12M, indicated by the dashed enclosures shown in FIG. 2. Specifically, the node 12J is simulating a model 20A for which ports A-D are defined; the node 12K is simulating a model 20B for which ports F, I and J are defined; the node 12L is simulating a model 20C for which port E is defined, and the node 12M is simulating a model 20D for which ports G-H are defined. Ports A-B are subports of port D (i.e. port D is a port including ports A and B, each of which include logical signals). Each of the nodes 12J-12M may be DSNs similar to nodes shown in FIG. 1.

Each of the models 20A-20D include physical signals, represented as solid lines emanating from the models 20A-20D (e.g. reference numeral 22 is a physical signal from the model 20A). Each of the ports A-J include other ports or logical signals, represented as solid lines emanating from the ports A-J (e.g. reference numeral 24 is a logical signal from the port A and reference numeral 26 is a solid line evidencing the inclusion of port B in port D. Solid lines between nodes (e.g. reference numeral 28 between port D and port F) indicate port connections between the nodes. The dotted lines between physical signals and logical signals indicate mappings of physical signals to logical signals (e.g. the dotted line between the physical signal 22 and the logical signal 24 illustrates the mapping of the physical signal 22 to the logical signal 24).

Generally, each of the models 20A-20D may be a simulatable model of a component of a system under test. The model may be an HDL model (e.g. a Verilog model, a VHDL model, etc.). The model may be a register transfer level (RTL) model of the design of the component. Alternatively, the model may be a behavioral description of the operation of the component, again written in HDL. The model may be a behavioral or functional model written in a verification language such as Vera® (Synopsys). Vera® may be a hardware verification language. A hardware verification language may provide a higher level of abstraction than an HDL. The model may also be coded in other languages (e.g. high level programming languages such as C or C++). It is further contemplated that a “model” could also be the hardware component, instantiated with interface logic allowing signals to be sampled and driven in response to the simulation.

The physical signals output by the models may be mapped to logical signals using one or more DDF commands, as illustrated by the dotted lines between physical signals and logical signals. Thus, DDF commands may map: (i) the physical signals from the model 20A to the logical signals of ports A, B, and C; (ii) the physical signals from the model 20B to the logical signals of ports I and J; (iii) the physical signals from the model 20C to the logical signals of port E; and (iv) the physical signals from the model 20D to the logical signals of ports G and H. The logical signals and logical port types (including port types corresponding to the hierarchical ports D and F) may be defined in one or more POV commands. Finally, the connections between ports from different nodes may be defined in one or more SCF commands. Particularly, SCF commands may specify connections between port D and port F, port B and port H, and port E to both ports C and G. Together, the DDF, POV, and SCF commands thus describe a system structure.

The logical signals corresponding to a given model may have a different bit order than the corresponding physical signals. Additionally, the physical signals may be divided into multiple logical signals, as desired.

FIG. 2 also illustrates that a port may be both a subport of a higher level port and may be connected to a port in another node. For example, port B may be connected to port H, and may also be a subport of port D.

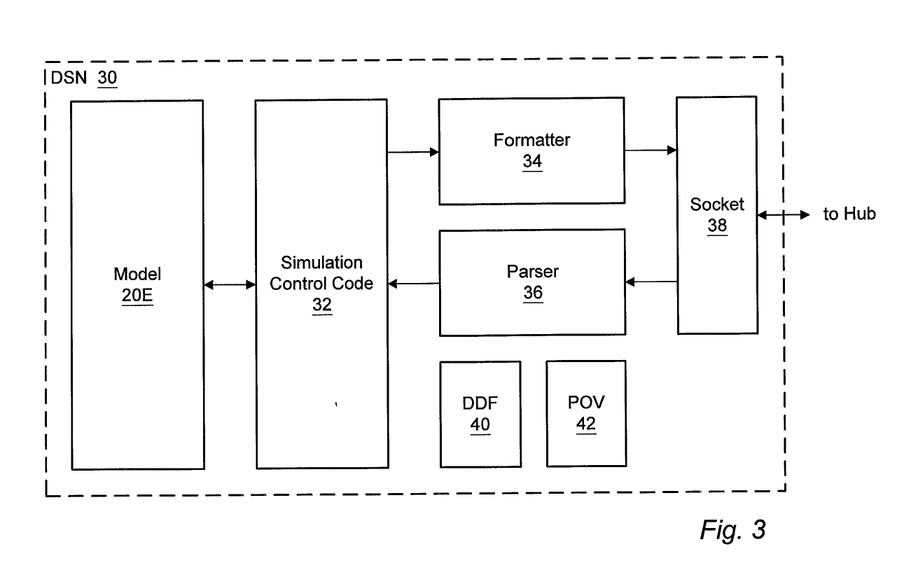

Turning now to FIG. 3, a block diagram of one embodiment of a DSN 30 is shown. The DSN 30 may be an example of instruction code components which may be included in a DSN node (e.g. nodes 12A, 12B, 12D, 12F, 12G, 12H and/or 12I in FIG. 1). Other embodiments are possible and contemplated. In the embodiment of FIG. 3, the DSN 30 includes a model 20E similar to the models 20A-20D shown in FIG. 2, simulation control code 32, a formatter 34, a parser 36, and a socket 38. Additionally, a DDF file 40 and a POV file 42 are shown. Each of the simulation control code 32, the formatter 34, the parser 36, and the socket 38 comprise instruction sequences for performing various functions. While illustrated separately in FIG. 3, these instruction sequences may be combined, as desired. The illustration in FIG. 3 is a logical partitioning of the function which may not be maintained in the actual program code files, if desired.

The simulation control code 32 is configured to interface with the model 20E and with the formatter 34 and parser 36. The simulation control code 32 may generally include any commercially available simulator, such as the NCVerilog program manufactured by Cadence Design Systems, Inc. (San Jose, Calif.); the VCS program manufactured by Synopsys, Inc. (Mountain View, Calif.); the VerilogXL simulator from Cadence; or the SystemSim program from Co-Design Automation, Inc. of Los Altos, Calif. for Verilog embodiments. Furthermore, the simulation control code 32 may include custom simulation code written to interface to the simulator, such as Vera® code which may be called at designated times during a simulation timestep by the simulator. The custom simulation code may include code to react to various grammar commands which may be transmitted to the DSN 30 from the hub.

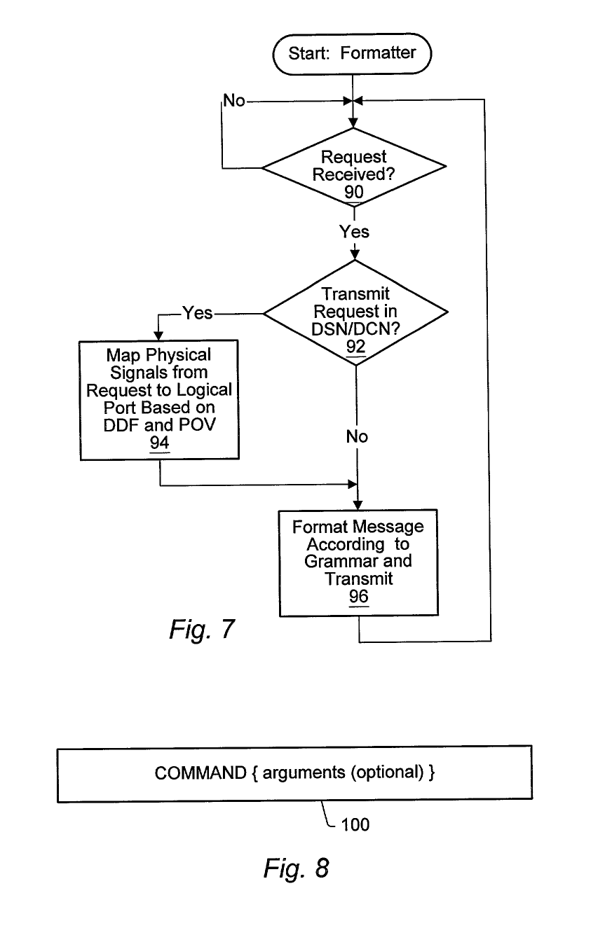

The formatter 34 receives communication requests from the simulation control code 32 and formats the requests according to the grammar for transmission to the hub. In other words, the formatter 34 generates message packets containing commands defined in the grammar based on the communication requests. A flowchart of one embodiment of the formatter 34 is shown in FIG. 7.

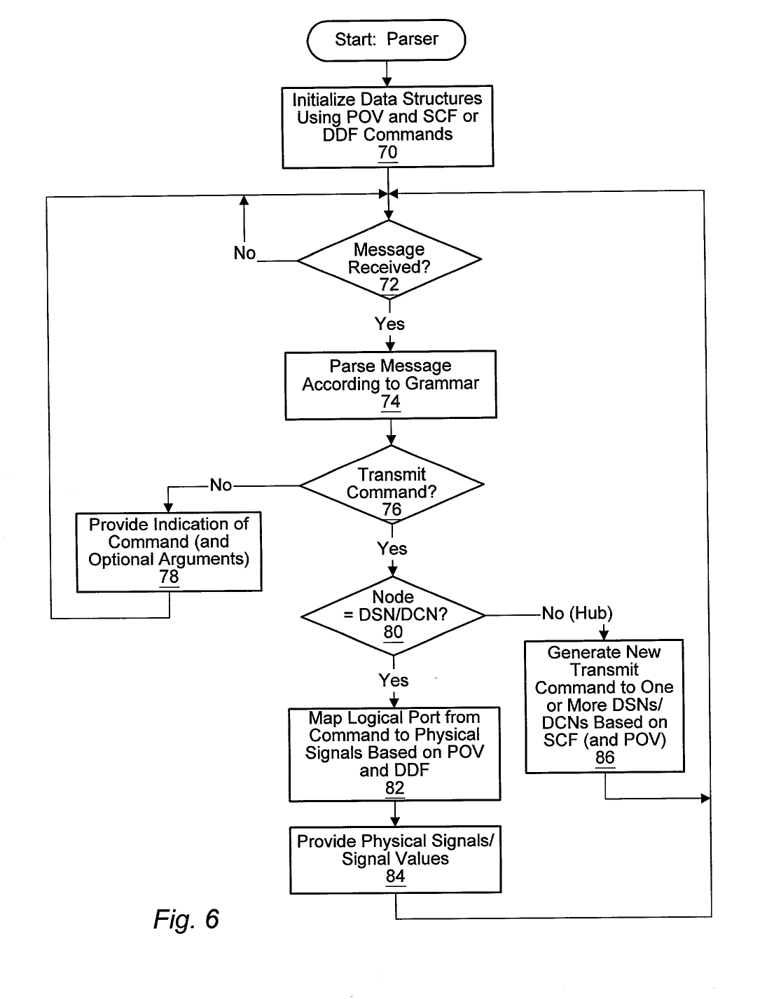

The parser 36 receives message packets from the socket 38 and parses the message packet according to the grammar. A flowchart of one embodiment of the parser 36 is illustrated in FIG. 6.

The socket 38 may be a generic Unix socket implementation for communicating with the hub. While one socket 38 is shown with bi-directional communication with the hub, other embodiments may include two independent sockets, each communicating in one direction (sending or receiving) with the hub. Multiple unidirectional or bidirectional sockets may be used, as desired.

The DDF and POV files 40 and 42 may store the DDF and POV commands for the DSN 30. Specifically, the DDF command may map the physical signals of the model 20E to logical signals specified in the POV command. The POV command may specify the logical signals and port types used by the DSN 30.

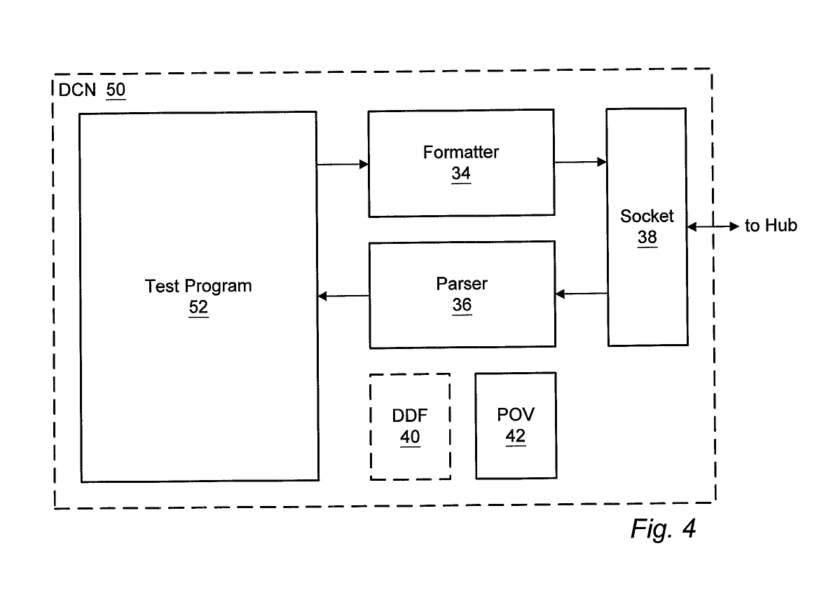

Turning now to FIG. 4, a block diagram of one embodiment of a DCN 50 is shown. The DCN 50 may be an example of instruction code components which may be included in a DCN node (e.g. node 12C in FIG. 1). Other embodiments are possible and contemplated. In the embodiment of FIG. 4, the DCN 50 includes a test program 52, the formatter 34, the parser 36, and the socket 38. Additionally, an optional DDF file 40 and the POV file 42 are shown. Each of the test program 52, the formatter 34, the parser 36, and the socket 38 comprise instruction sequences for performing various functions. While illustrated separately in FIG. 4, these instruction sequences may be combined, as desired. The illustration in FIG. 4 is a logical partitioning of the function which may not be maintained in the actual program code files, if desired.

The test program 52 may be programmed for any desired test operation. For example, the test program 52 may be configured to inject errors or provide non-error values at a given point or points in the system under test at a given time or times during the simulation. The test program 52 may be configured to transmit the error or non-error value as a signal transmission message packet at the given time, formatted according to the POV file 42 (by the formatter 34). The test program 52 may be configured to monitor for certain events in the simulation (e.g. by receiving signal transmission message packets from custom code in the desired DSN 30). Alternatively, the test program 52 may create one or more dummy physical signals for the signals to be monitored. The DDF file 40 may map the dummy physical signals to logical signals, and the SCF file in the hub may include a connection from the logical port of the node to be monitored to the logical port of the DCN 50. The DCN 50 may be configured to perform command/control functions for the simulation as a whole. In general, any desired test operation may be performed by the test program 52.

The POV file 42 is used if the test program 52 transmits or receives signal transmission message packets, for formatting or parsing the packets, respectively. The DDF file 40 is optional, and may be used if the test program 52 creates dummy physical signals for monitoring purposes or other purposes.

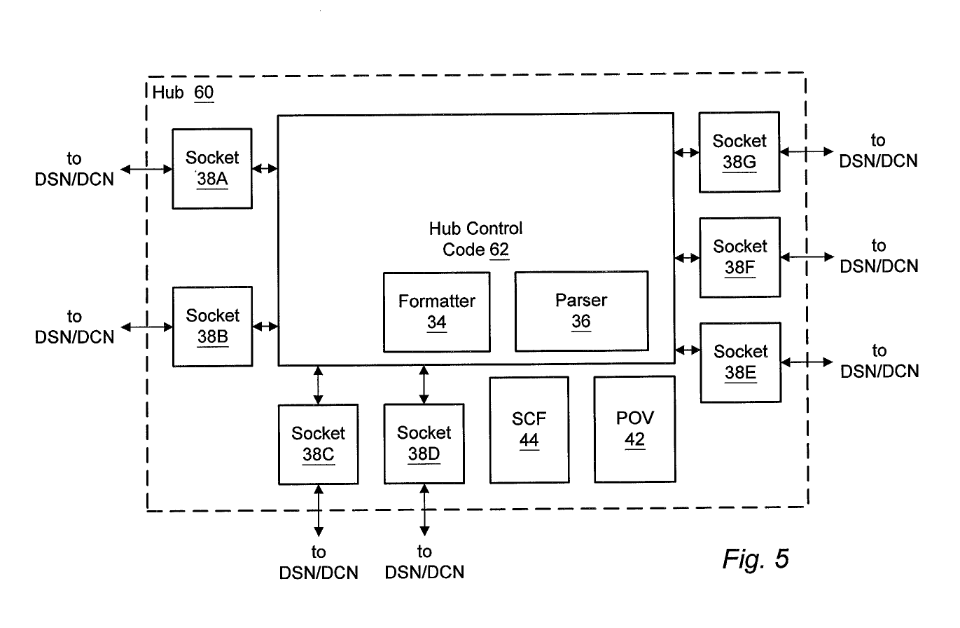

Turning now to FIG. 5, a block diagram of one embodiment of a hub 60 is shown. The hub 60 may be an example of instruction code components which may be included in a hub node (e.g. nodes 12E in FIG. 1). Other embodiments are possible and contemplated. In the embodiment of FIG. 5, the hub 60 includes a hub control code 62 (which may include the formatter 34 and the parser 36), a set of sockets 38A-38G (the number of which may be equal to the number of DSNs and DCNs, or a multiple of the number if more than one socket is used per node), the POV file 42, and an SCF file 44. The sockets 38A-38G may each be similar to the socket 38 described above. Similar to the POV file 42 and the DDF file 40, the SCF file 44 may store the SCF command for the distributed simulation system. The hub control code 62 may use the SCF command to determine which nodes are to be instantiated at the beginning of the simulation (as well as the names of those nodes) and may use the routing information in the SCF command for routing signal transmission message packets. That is, the routing information is the information which specifies port connections in the system under test.

The hub control code 62 may generally receive message packets from the sockets 38A-38G. The hub control code 62 may process each message packet, which may result in generating message packets for other nodes (or for the source node of the message packet). For example, signal transmission message packets containing signals for a given logical port of the sending DSN may result in one or more signal transmission message packets to other nodes which are connected to the logical port in the SCF command. Other types of commands may be used by the hub itself (e.g. for synchronizing the DSNs during the simulation) or may be routed to other nodes (e.g. the user command described in more detail below). The hub control code 62 may use the parser 36 for parsing the received message packets and may use the formatter 34 for formatting the message packets to be transmitted, in a manner similar to the discussion above for DSNs and DCNs.

In one embodiment, the hub control code 62 may be multithreaded, with a separate thread for each socket. The thread may receive a message packet from the socket, and invoke the parser 36 to parse the message packet. The thread may also receive message packets from the formatter 34 for transmission on the corresponding socket 38A-38G. The parser 36 and formatter 34 may be shared among the threads, or there may be separate copies of the parser 36 and the formatter 34 for each thread.

Grammar for Communicating in a Distributed Simulation System

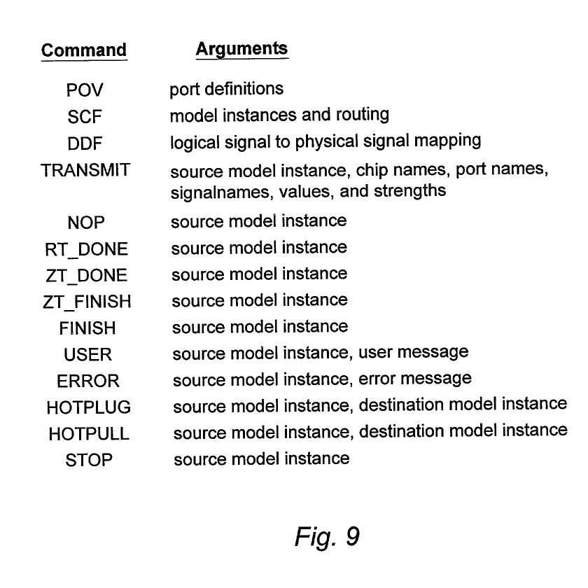

As FIGS. 3-5 illustrate, a formatter and parser are used to generate and interpret the message packets transmitted between the nodes. Thus, the grammar may form a common application programming interface (API) between the nodes. The grammar may define a more human readable message packet format, which may allow the user to more readily learn to use the distributed simulation system, to interpret the sequence of events within the system, and to control the simulation in a desired fashion. For example, abstract simulation commands may be defined, which the user may employ to implement a desired test. An exemplary set of commands is shown below in FIG. 9. Additionally, the abstraction of physical signals to logical ports may allow for more human readable transmission of signal values, as discussed above.

Turning now to FIG. 6, a flowchart is shown illustrating operation of one embodiment of the parser 36. Other embodiments are possible and contemplated. Blocks are illustrated in a particular order for ease of understanding, but any order may be used. Blocks may be performed in parallel, if desired. Generally, the flowchart of FIG. 6 may represent a sequence of instructions comprising the parser 36 which, when executed, perform the operation shown in FIG. 6.

The parser 36 initializes data structures used by the parser 36 (and the formatter 34) using the POV command and the SCF or DDF commands, if applicable (block 70). Alternatively, block 70 may be performed by an initialization routine or initialization script separate from the parser 36. The data structures formed from the POV command and the SCF or DDF commands may be any type of data structure which may be used to store the information conveyed by the commands. For example, hash tables may be used.

The parser 36 waits for a message packet to be received (decision block 72). The decision block 72 may represent polling for a message packet, or may represent the parser 36 being inactive (“asleep”) until a call to the parser 36 is made with the message packet as an operand.

In response to a message packet, the parser 36 parses the message packet according to the grammar (block 74). The grammar specifies the format and content of the message packet at a high level, and additional specification for signal transmission message packets is provided by the POV command defined in the grammar. The grammar may be defined in the Backus-Naur Form (BNF), allowing a software tool such as the Unix tools lex/flex and yacc/bison to be used to automatically generate the parser.

The message packet may be received from the socket 38, if the parser 36 is operating in a DSN 30 or DCN 50. The message packet may be received from any of a variety of sockets, if the parser 36 is operating in a hub 60. In the present embodiment, the same parser 36 may be used in the hub and the DSNs/DCNs. However, in other embodiments, separate parsers may be created for the hub and for the DCNs/DSNs. In such embodiments, the parser for the hub may implement the hub portion of the flowchart in FIG. 6 and the parser for the DCNs/DSNs may implement the DCN/DSN portion of the flowchart in FIG. 6.

If the message packet is not a transmit command (a signal transmission message packet) (block 76), then the message packet is a command for the receiving code (e.g. the simulation control code 32, the test program 52, or the hub control code 62). The parser 36 may provide an indication of the received command, as well as an indication of arguments if arguments are included, to the receiving program (block 78). The receiving program may respond to the message as appropriate. The parser 36 waits for the next message to be received.

If the message packet is a transmit command, the operation depends on whether the node is a DSN/DCN or a hub (decision block 80). If the node is a DSN/DCN, the parser 36 maps the logical port in the transmit command to physical signals, using the information provided in the POV and DDF commands (block 82). The parser 36 may then provide the physical signal names and corresponding values to the simulation control code 32 or the test program 52 (block 84). The parser 36 waits for the next message to be received.

If the node is a hub, the parser 36 may generate new transmit commands to one or more other DSNs/DCNs according to the port connections specified in the SCF command (and POV commands) (block 86). Specifically, the SCF may specify routings from a port on which a transmit command is received to one or more other ports in other nodes. Each routing expression may be viewed as a connection between the port on which the transmit command is received and the other port in the routing expression. Each routing results in a new transmit command, provided to the thread/socket which communicates with the destination node of that routing. The SCF command may specify the information used to generate the new transmit command in the routing expression. Specifically, as shown in more detail below, the routing expression includes a model instance name and one or more port names (where, if more than one port name is included, the ports are hierarchically related). Accordingly, the model instance name and the port names of the destination portion of the expression may be used to replace the model instance name and port names in the received transmit command to generate the new transmit command. The parser 36 waits for the next message to be received.

It is noted that the parser 36 may also be configured to detect a message packet which is in error (that is, a message packet which is unparseable according to the grammar). Error handling may be performed in a variety of fashions. For example, the erroneous message packet may be ignored. Alternatively, the parser 36 may pass an indication of an error to the receiving code, similar to block 78. In yet another alternative, the parser 36 may return an error message to the hub (or provide an error indication to the formatter 34, which may return an error message packet).

Turning now to FIG. 7, a flowchart is shown illustrating operation of one embodiment of the formatter 34. Other embodiments are possible and contemplated. Blocks are illustrated in a particular order for ease of understanding, but any order may be used. Blocks may be performed in parallel, if desired. Generally, the flowchart of FIG. 7 may represent a sequence of instructions comprising the formatter 34 which, when executed, perform the operation shown in FIG. 7.

The formatter 34 waits for a request to send a message packet (decision block 90). The decision block 90 may represent polling for a request, or may represent the formatter 34 being inactive until a call to the formatter 34 is made with the request information as an operand.

If the request is a transmit request in a DSN/DCN (decision block 92), the formatter 34 maps the physical signals provided in the request to a logical port based on the DDF and POV commands (block 94). The formatter 34 may use the same data structures used by the parser 36 (created from the DDF and POV commands), or separate data structures created for the formatter 34 from the DDF and POV commands. Generally, a request to transmit signals may include signals that belong to different logical ports. The formatter 34 may generate one message packet per logical port, or the transmit command may handle multiple ports in one message packet. Alternatively, the request may include the logical signals and the formatter may not perform the mapping from physical signals to logical signals.

The formatter formats a message packet according to the grammar definition and transmits the message packet to the socket (block 96). An example message packet is shown in FIG. 8.

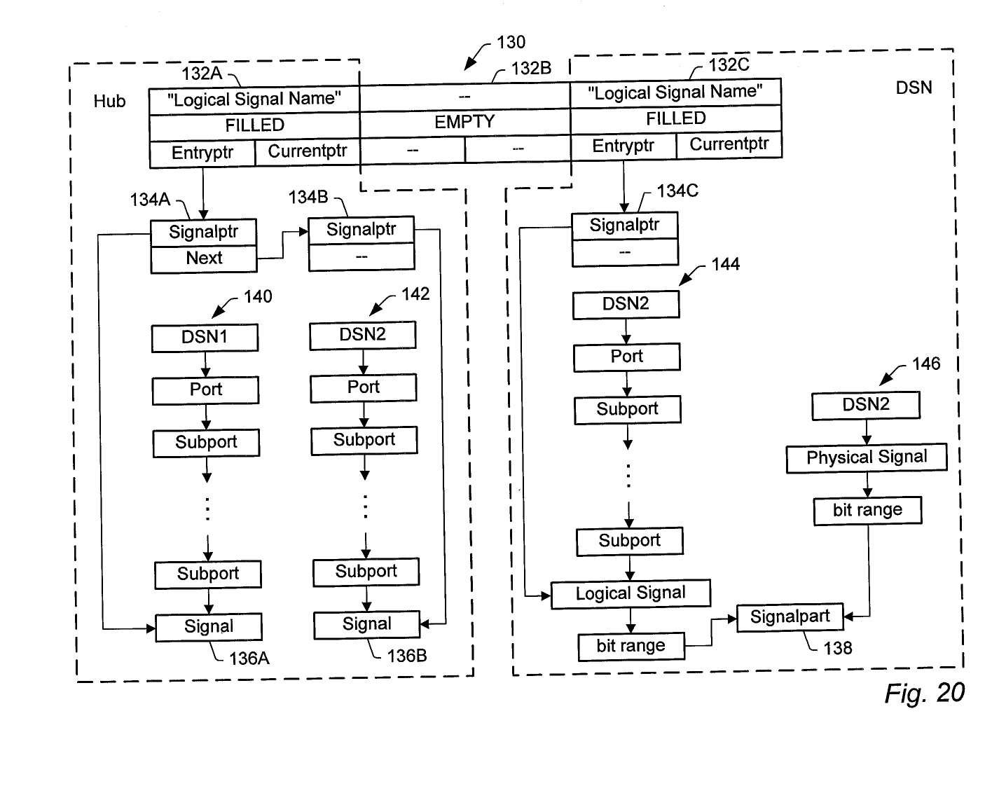

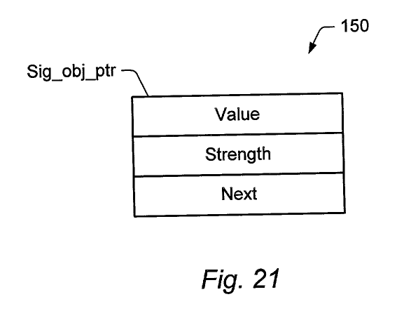

FIG. 20 is a block diagram illustrating an exemplary data structure 130 which may be used by one embodiment of the parser shown in FIG. 6. The data structure 130 may include a hash table, with illustrative entries 132A, 132B, and 132C illustrated in FIG. 20. Each hash table entry 132A-132C may include a character string listing the logical signal name (“Logical Signal Name” in FIG. 20), a value indicating whether or not the entry 132A-132C is valid (“FILLED” for valid and “EMPTY” for not valid in FIG. 20), a pointer (“Entryptr” in FIG. 20) to a linked list of signal pointers (e.g. list elements 134A, 134B, and 134C in FIG. 20, where the signal pointer is labeled Signalptr in the list element and the pointer to the next element is the Next field), and a second pointer (“Currentptr” in FIG. 20). In FIG. 20, if a pointer is Nil or a field is not valid, a “—” is shown in that field. For example, in the hash table entry 132B, the logical signal name is not valid and the Currentptr and Entryptr fields are Nil. Additionally, child-sibling trees are used in the hub to represent the logical port/signal structure of each DSN (e.g. reference numeral 140 for DSN1 and reference numeral 142 for DSN2). Each logical tree may include a top level name (e.g. DSN1), one or more ports, zero or more subports for each port, and logical signal names. A child-sibling tree is also used in the DSN to represent the logical port/signal structure of that DSN (e.g. reference numeral 144) and to represent the physical signal structure (e.g. reference numeral 146). In this case, the logical signal and/or physical signal may also have one or more bit range children.

The hash table may be used in both the hub and in the DSNs for parsing logical signals from a transmit message. The entry 132A is illustrated with hub data structures, while the entry 132C is illustrated with DSN data structures. The hub and the DSNs may each have their own copy of the hash table. During initialization, the parser may build the hash table and linked list of signal pointers based on the POV command (and the SCF command in the hub). The child-sibling tree for the physical signal structure may also be built by the parser using the DDF command in the DSN. Each signal pointer points to a leaf in the logical child-sibling trees that represent the logical port/signal structure of a DSN node. A linked list is used to allow multiple signal routings from a given hash table entry (in the hub) or multiple logical signal connections (in the DSN, e.g. the forall structure used in the DDF command). Other data structures may be used in other embodiments.

The parser in the hub detects a transmitted logical signal name in the hash table, and uses the linked list of signal pointers to identify logical signals in various nodes to which that logical signal is routed. For example, in FIG. 20, the logical signal corresponding to the hash table entry 132A is routed to logical signals in DSN1 and DSN2. Accordingly, signal pointers point to the logical signals 136A and 136B within the trees representing the logical port/signal structure of DSN1 and DSN2.

The parser in the DSN detects a transmitted logical signal name in the hash table, and uses the linked list of signal pointers to identify the logical signal in the DSN's child-sibling tree that represents its logical port/signal structure. The logical signal may have a bit range, which is linked to a Signalpart data structure 138 representing that signal. The signal value (and strength) may be stored in the Signalpart data structure 138 pointed to by the bit range (or pointed to by the logical signal, if no bit range is provided). The physical signal child-sibling tree may also point to the Signalpart data structure 138, whereby the logical signal is mapped to the corresponding physical signal (and bit range of that physical signal, if applicable).

The Currentptr may be used in cases where the linked list of signal pointers includes more than one element, to traverse the linked list. While the Entryptr points to the head of the list, the Currentptr may point to any element in the list as the list is processed by the parser.

FIG. 21 is a block diagram illustrating an exemplary data structure 150 which may be used by one embodiment of the formatter shown in FIG. 7. In this case, the formatter may be passed a pointer (Sig_obj_ptr) to a data structure including a value, a strength, and a next pointer (which may be Nil in this case). The value and strength are to be transmitted for a corresponding logical signal. The formatter may be informed of the address of the logical signal (and thus the logical signal name) expressly or impliedly. Alternatively, the formatter may be passed the logical signal name expressly or impliedly.

Turning next to FIG. 8, a block diagram of a message packet 100 is shown. Other embodiments are possible and contemplated. Generally, a message packet is a packet including one or more commands and any arguments of each command. The message packet may be encoded in any fashion (e.g. binary, text, etc.). In one embodiment, a message packet is a string of characters formatted according to the grammar. The message packet may comprise one or more characters defined to be a command (“COMMAND” in FIG. 8), followed by an opening separator character (defined to be an open brace in this embodiment, but any character may be used), followed by optional arguments, followed by a closing separator character (defined to be a close brace in this embodiment, but any character may be used). In BNF, the packet may be described as: COMMAND “{” arguments “}”. COMMAND is a token comprising any string of characters which is defined to be a command. A list of commands are illustrated in FIG. 9 for an exemplary embodiment. Arguments are defined as: |arguments one_argument. One_argument has a definition which depends on the command type.

It is noted that, when BNF definitions are used herein, words shown in upper case are tokens for the lexer used in the generation of the parser while words shown in lower case are terms defined in other BNF expressions.

FIG. 9 is a table illustrating an exemplary set of commands and the arguments allowed for each command. Other embodiments may include other command sets, including subsets and supersets of the list in FIG. 9. Under the Command column is the string of characters used in the message packet to identify the command. Under the Arguments column is the list of arguments which may be included in the command.

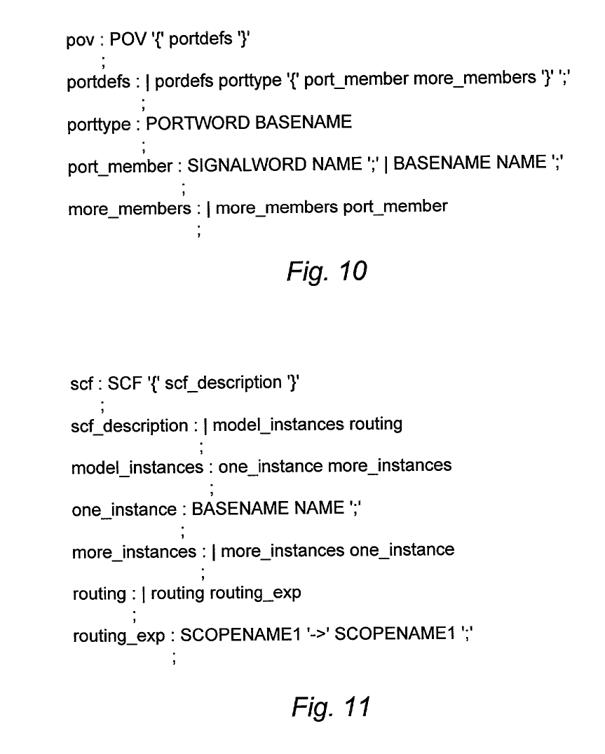

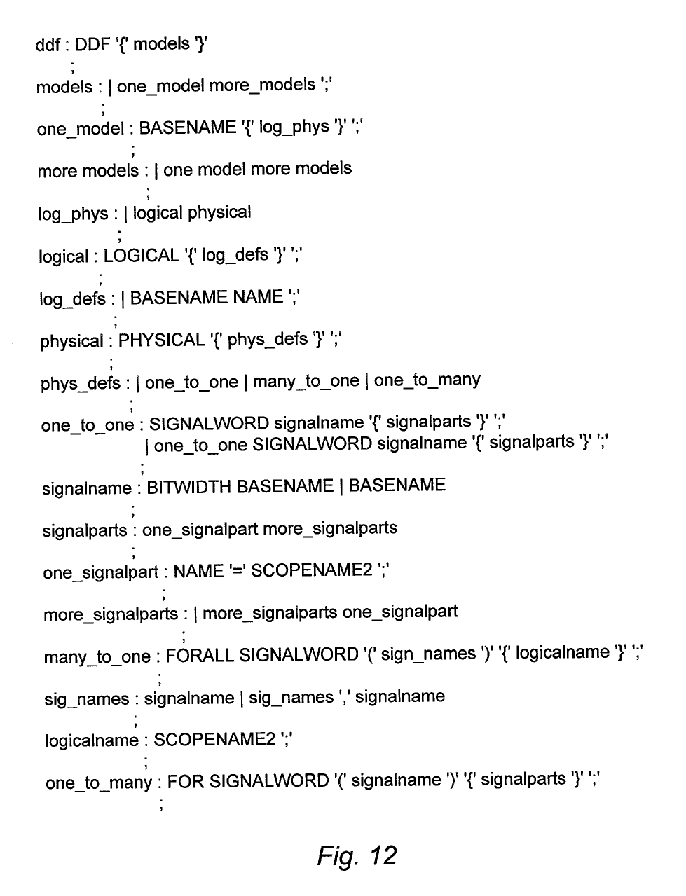

The POV, SCF, and DDF commands have been introduced in the above description. Additionally, FIGS. 10-12 provide descriptions of these commands in BNF. Generally, the POV command has the port type definitions as its arguments; the SCF command has model instances (i.e. the names of the models in each of the DSNs) and routing expressions as its arguments; and the DDF command has logical signal to physical signal mappings as its arguments. These commands will be described in more detail below with regard to FIGS. 10-12.

The TRANSMIT command is used to transmit signal values from one port to another. That is, the TRANSMIT command is the signal transmission message packet in the distributed simulation system. Generally, the transmit command includes the name of the model for which the signals are being transmitted (which is the model name of the source of the signals, for a packet transmitted from a DSN/DCN to the hub, or the model name of the receiver of the signals, for a packet transmitted by the hub to a DSN/DCN), one or more ports in the port hierarchy, logical signal names, and assignments of values to those signal names. For example, the TRANSMIT command may be formed as follows:

TRANSMIT{model{port{signalname={value=INT;strength=POTENCY;};}}}

Where the port may include one or more subports (e.g. port may be port{subport, repeating subport as many times as needed to represent the hierarchy of ports until the logical signal names are encountered). Additional closing braces would be added at the end to match the subport open braces. The TRANSMIT command may be represented in BNF as follows:

```
transmit : TRANSMIT ′{′ chip ′{′ ports ′}′′}′
      ;
chip : chipportname
    ;
ports : | ports chipportname ′{′ ports data ′}′
    ;
chipportname : PORT
        ;
data : | data dataline ports
    ;
dataline : NAME ′=′ ′{′ signalparts ′}′
      ;
signalparts : VALUE ′=′ INT ′;′
| VALUE ′=′ INT ′;′ STRENGTH ′=′ POTENCY ′;′
| VALUE ′=′ BIN ′;′
| VALUE ′=′ BIN ′;′ STRENGTH ′=′ POTENCY ′;′
| VALUE ′=′ HEX ′;′
| VALUE ′=′ HEX ′;′ STRENGTH ′=′ POTENCY ′;′
;
```

where the following are the token definitions: TRANSMIT is the “TRANSMIT” keyword, PORT is a port type defined in the POV command (preceded, in one embodiment, by a period), NAME is a logical signal name, VALUE is the “value” keyword, INT is an integer number, BIN is a binary number, and HEX is a hexadecimal number, STRENGTH is the “strength” keyword, and POTENCY is any valid signal strength as defined in the HDL being used (although the actual representation of the strength may vary).

The signal strength may be used to simulate conditions in which more than one source may be driving a signal at the same time. For example, boards frequently include pull up or pull down resistors to provide values on signals that may not be actively driven (e.g. high impedance) all the time. An active drive on the signal may overcome the pull up or pull down. To simulate such situations, signal strengths may be used. The pull up may be given a weak strength, such that an active drive (given a strong strength) may produce a desired value even though the weak pull up or pull down is also driving the same signal. Thus signal strength is a relative indication of the ability to drive a signal to a desired value. In one embodiment, the signal strengths may include the strengths specified by the IEEE 1364-1995 standard. For example, the strengths may include (in order of strength from strongest to weakest): supply drive, strong drive, pull drive, large capacitor, weak drive, medium capacitor, small capacitor and high impedance. The strengths may also include the 65× strength (an unknown value with a strong driving 0 component and a pull driving 1 component) and a 520 strength (a 0 value with a range of possible strengths from pull driving to medium capacitor).

The NOP command is defined to do nothing. The NOP command may be used as an acknowledgment of other commands, to indicate completion of such commands, for synchronization purposes, etc. The NOP command may have a source model instance argument in the present embodiment, although other embodiments may include a NOP command that has no arguments or other arguments The NOP command may also allow for reduced message traffic in the system, since a node may send a NOP command instead of a transmit command when there is no change in the output signal values within the node, for example.

The RT_DONE, ZT_DONE, ZT_FINISH, and FINISH commands may be used to transition DSNs between two phases of operation in the distributed simulation system, for one embodiment. In this embodiment, each simulator timestep includes a real time phase and a zero time phase. In the real time phase, simulator time advances within the timestep. In the zero time phase, simulator time is frozen. Messages, including TRANSMIT commands, may be performed in either phase. The RT_DONE command is used by the hub to signal the end of a real time phase, and the ZT_DONE command is used by the hub to indicate that a zero time phase is done. The ZT_FINISH command is used by the DSN/DCN nodes to signal the end of a zero time phase in asynchronous embodiments of zero time. The FINISH command is used to indicate that the simulation is complete. Each of the RT_DONE, ZT_DONE, ZT_FINISH, and FINISH commands may include a source model instance argument.

The USER command may be used to pass user-defined messages between nodes. The USER command may provide flexibility to allow the user to accomplish simulation goals even if the communication used to meet the goals is not directly provided by commands defined in the grammar. The arguments of the USER command may include a source model instance and a string of characters comprising the user message. The user message may be code to be executed by the receiving node (e.g. C, Vera®, Verilog, etc.), or may be a text message to be interpreted by program code executing at the receiving node, as desired. In one embodiment, the routing for the USER command is part of the user message.

The ERROR command may be used to provide an error message, with the text of the error message and a source model instance being arguments of the command.

The HOTPLUG and HOTPULL commands may be used to simulate the hot plugging or hot pulling of a component. A component is “hot plugged” if it is inserted into the system under test while the system under test is powered up (i.e. the system under test, when built as a hardware system, is not turned off prior to inserting the component). A component is “hot pulled” if it is removed from the system under test while the system is powered up. A node receiving the HOTPLUG command may begin transmitting and receiving message packets within the distributed simulation system. A node receiving the HOTPULL command may cease transmitting message packets or responding to any message packets that may be sent to the node by other nodes. The HOTPLUG and HOTPULL commands may include a source model instance argument and a destination model instance argument (where the destination model instance corresponds to the component being hot plugged or hot pulled).

The STOP command may be used to pause the simulation (that is, to freeze the simulation state but not to end the simulation). The STOP command may include a source model instance argument.

FIGS. 10-12 are BNF descriptions of the POV, SCF, and DDF commands, respectively, for one embodiment of the grammar. Other embodiments are possible and contemplated. As mentioned above, the words shown in upper case are tokens for the lexer used in the generation of the parser while words shown in lower case are terms defined in other BNF expressions.

Generally, the POV command includes one or more port type definitions. In the present embodiment, the POV command includes two data types: ports and signals. Signals are defined within ports, and ports may be members of other ports. The signal is a user defined logical signal, and the port is a grouping of other ports and/or signals. Each port type definition begins with the “port” keyword, followed by the name of the port, followed by a brace-enclosed list of port members (which may be other ports or signals). Signals are denoted in a port definition by the keyword “signal”. Ports are denoted in a port definition by using the port name, followed by another name used to reference that port within the higher level port.

The SCF command includes an enumeration of the model instances within the system under test (each of which becomes a DSN or DCN in the distributed simulation system) and a set of routing expressions which define the connections between the logical ports of the model instances. The model instances are declared using a model type followed by a name for the model instance. A DDF command is provided for the model type to define its physical signal to logical signal mapping. The model name is used in the TRANSMIT commands, as well as in the routing expressions within the SCF command. Each routing expression names a source port and a destination port. TRANSMIT commands are routed from the source port to the destination port. The port name in these expressions is hierarchical, beginning with the model instance name and using a “.” as the access operator for accessing the next level in the hierarchy. Thus, a minimum port specification in a routing expression is of the form model_name.port_name1. A routing expression for routing the port_name2 subport of port_name1 uses model_name.port_name1.port_name2. In this example, a routing expression of the form model_name port_name1 may route any signals encompassed by port_name1 (including those within port_name2). On the other hand, a routing expression of the form model_name.port_name1.port_name2 routes only the signals encompassed by port_name2 (and not other signals encompassed by port_name1 but not port_name2). The routing operator is defined, in this embodiment, to be “→” where the source port is on the left side of the routing operator and the destination port is on the right side of the routing operator.

In the SCF command, bi-directional ports may be created using two routing expressions. The first routing expression routes the first port (as a source port) to the second port (as a destination port) and the second routing expression routes the second port (as a source port) to the first port (as a destination port). Additionally, a single port may be routed to two or more destination ports using multiple routine expressions with the single port as the source port and one of the desired destination ports as the destination port of the routing expression.

As mentioned above, the DDF command specifies the physical signal to logical signal mapping for each model type. In the present embodiment, the DDF command is divided into logical and physical sections. The logical section enumerates the logical ports used by the model type. The same port type may be instantiated more than once, with different port instance names. The physical section maps physical signal names to the logical signals defined in the logical ports enumerated in the logical section. In one embodiment, the DDF command provides for three different types of signal mappings: one-to-one, one-to-many, and many-to-one. In a one-to-one mapping, each physical signal is mapped to one logical signal. In a one-to-many mapping, one physical signal is mapped to more than one logical signal. The “for” keyword is used to define a one-to-many mapping. One-to-many mappings may be used if the physical signal is an output. In a many-to-one mapping, more than one physical signal is mapped to the same logical signal. The “forall” keyword is used to define a many-to-one mapping. Many-to-one mappings may be used if the physical signals are inputs.

The DDF commands allow for the flexibility of mapping portions of multi-bit signals to different logical signals (and not mapping portions of multi-bit physical signals at all). The signalpart type is defined to support this. A signalpart is the left side of a physical signal to logical signal assignment in the physical section of a DDF command. If a portion of a multi-bit physical signal, or a logical signal, is not mapped in a given DDF command, a default mapping is assigned to ensure that each physical and logical signal is assigned (even though the assignment isn't used). The “default logical” keyword is used to define the default mappings of logical signals not connected to a physical signal.

For the BNF descriptions in FIGS. 10-12, the tokens shown have the following definitions: POV is the “POV” command name; PORTWORD is the “port” keyword; NAME is a legal HDL signal name, including the bit index portion (e.g. [x:y] or [z], where x, y, and z are numbers, in a Verilog embodiment) if the signal includes more than one bit; BASENAME is the same as NAME but excludes the bit index portion; SIGNALWORD is the “signal” or “signals” keywords; SCF is the “SCF” command name; SCOPENAME1 is a scoped name using BASENAMES (e.g. BASENAME.BASENAME.BASENAME); DDF is the “DDF” command name; LOGICAL is the “logical” keyword; PHYSICAL is the “physical” keyword; BITWIDTH is the bit index portion of a signal; FORALL is the “forall” keyword; “FOR” is the “for” keyword; and SCOPENAME2 is scoped name using NAMES (e.g. NAME.NAME.NAME).

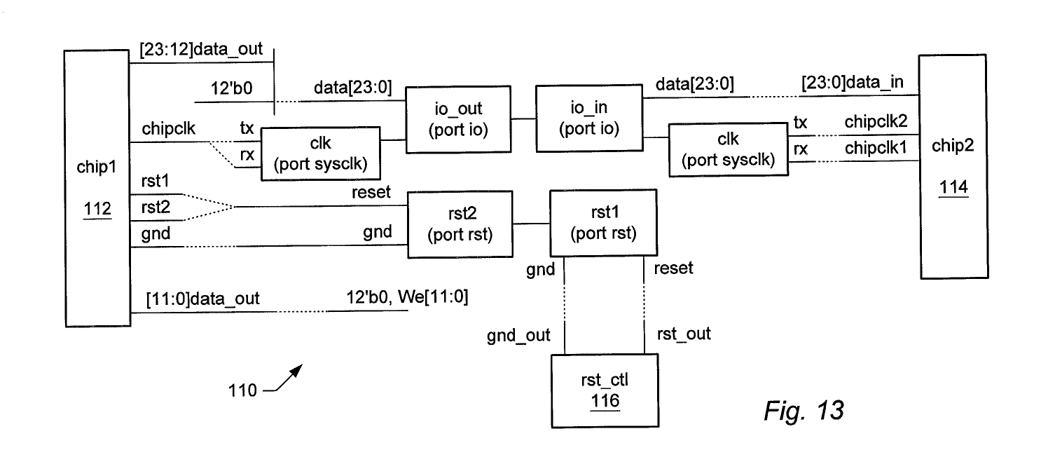

FIGS. 13-18 illustrate an exemplary system under test 110 and a set of POV, DDF, and SCF commands for creating a distributed simulation system for the system under test. In the example, the system under test 110 includes a first chip (chip 1) 112, a second chip (chip 2) 114, and a reset controller circuit (rst_ctl) 116. Each of the chip 1 112, the chip 2 114, and the rst_ctl 116 may be represented by separate HDL models (or other types of models). The signal format used in FIGS. 13-18 is the Verilog format, although other formats may be used.

The chip 1 112 includes a data output signal ([23:0]data_out), a clock output signal (chipclk), two reset inputs (rst1 and rst2), and a ground input (gnd). The chip 2 114 includes a data input signal ([23:0]data_in) and two clock input signals (chipclk1 and chipclk2). The rst_ctl 116 provides a ground output signal (gnd out) and a reset output signal (rst_out). All of the signals in this paragraph are physical signals.

Several ports are defined in the example. Specifically, the port types io, sysclk, and rst are defined. The sysclk port type is a subport of the io port type, and has two logical signal members (tx and rx). The io port type has a clk subport of the sysclk port type and a data signal (having 24 bits) as a member. Two instantiations of io port type are provided (io_out and io_in), and two instantiations of the rst port type are provided (rst1 and rst2). In this example, the port io_out is routed to the port io_in and the port rst1 is routed to the port rst2.

In this example, only the most significant 12 bits of the data output signal of the chip 1 112 are routed to other components (specifically, the chip2 114). Thus, the most significant 12 bits of the data output signal are mapped to the most significant bits of the logical signal data[23:0] of the port io_out. The least significant bits are assigned binary zeros as a default mapping, although any value could be used. The chipclk signal of chip1 112 is mapped to both the logical clock signals tx and rx of the port clk. The rst1 and rst2 input signals of chip 1 112 are both mapped to the reset logical signal of the port rst2. The gnd input signal is mapped to the gnd logical signal of the rst2 port.

The data input signal of the chip 2 114 is mapped to the data[23:0] logical signal of port io_in. The chipclk1 signal is mapped to the rx logical signal of the port clk, and the chipclk2 signal is mapped to the tx logical signal of the port clk. Finally, the gnd_out signal of rst_ctl 116 is mapped to the gnd logical signal of port rst1 and the rst_out signal of rst_ctl 116 is mapped to the reset logical signal of port rst1.

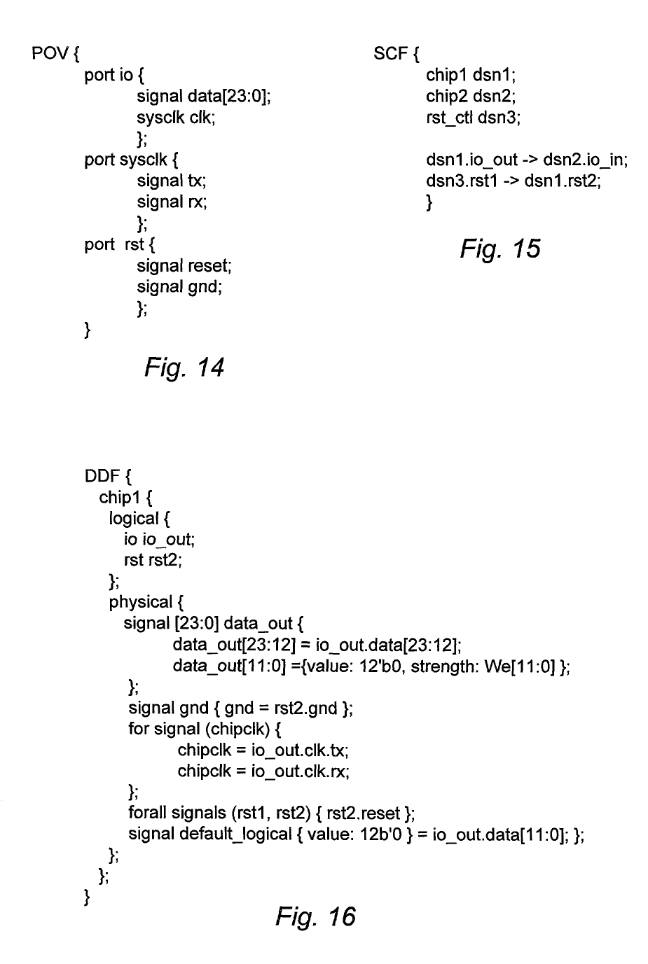

FIG. 14 is an example POV command for the system under test 110. The POV command defines the three port types (io, sysclk, and rst), and the logical signals included in each port type. Port type io includes the logical signal data[23:0] and the subport clk of port type sysclock. Port type sysclock includes the logical signals tx and rx; and the port type rst includes logical signals reset and gnd.

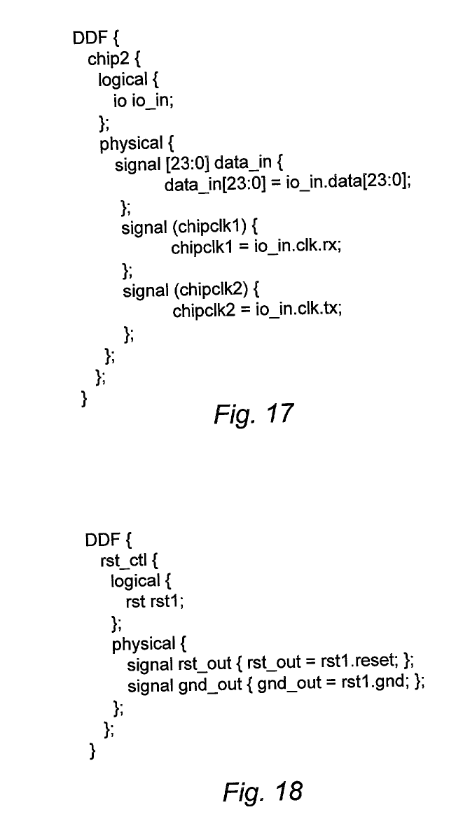

FIG. 15 is an example SCF command for the system under test 110. The SCF file declares three model instances: dsn1 of model type chip1 (for which the DDF command is shown in FIG. 16); dsn2 of model type chip2 (for which the DDF command is shown in FIG. 17); and dsn3 of model type rst_ctl (for which the DDF command is shown in FIG. 18). Additionally, the SCF command includes two routing expressions. The first routing expression (dsn1.io_out→dsn2.io_in) routes the io_out port of model dsn1 to the io_in port of model dsn2. The second routing expression (dsn3.rst1→dsn1.rst2) routes the rst1 port of dsn3 to the rst2 port of dsn1.

Thus, for example, a transmit command received from dsn3 as follows:

TRANSMIT{.dsn3{.rst1{gnd={value=0;};reset={value=1;};}}}

causes the hub to generate a transmit command to dsn1 (due to the second routing expression, by substituting dsn1 and rst2 for dsn3 and rst1, respectively):

TRANSMIT{.dsn1{.rst2{gnd={value=0;};reset={value=1;};}}}

As mentioned above, the parser in the hub may parse the transmit command received from dsn3 and may route the logical signals using the child-sibling trees and hash table, and the formatter may construct the command to dsn1.

In the DDF command for chip1 (FIG. 16), the logical section instantiates two logical ports (io_out of port type io, and rst2 of port type rst). The physical section includes a one-to-one mapping of the data output signal in two parts: the most significant 12 bits and the least significant 12 bits. The most significant 12 bits are mapped to the logical signal io_out.data[23:12]. The least significant 12 bits are mapped to the weak binary zero signals. A one-to-one mapping of the physical signal gnd to the logical signal rst2.gnd is included as well.

The physical section also includes a one-to-many mapping for the chipclk signal. The keyword “for” is used to signify the one-to-many mapping, and the assignments within the braces map the chipclk signal to both the logical signals in the clk subport: io_out.clk.tx and io_out.clk.rx.

The physical section further includes a many-to-one mapping for the rst1 and rst2 physical signals. Both signals are mapped to the logical signal rs2.reset. The keyword “forall” is used to signify the many-to-one mapping. The physical signals mapped are listed in the parentheses (rst1 and rst2 in this example), and the logical signal to which they are mapped is listed in the braces (rst2.reset in this example).

Finally, the physical section includes a default logical signal mapping, providing a default value for the least significant 12 bits of the logical signal io_out.data. Specifically, binary zeros are used in this case.

Accordingly, the DDF command in FIG. 16 illustrates the one-to-one, many-to-one, and one-to-many mappings described above.

FIG. 17 illustrates the DDF command for chip2, with a single logical port io_in of port type io in the logical section and one-to-one signal mappings in the physical section. Similarly, FIG. 18 illustrates the DDF command for rst_ctl, with a single logical port rst1 of port type rst and one-to-one signal mappings in the physical section.

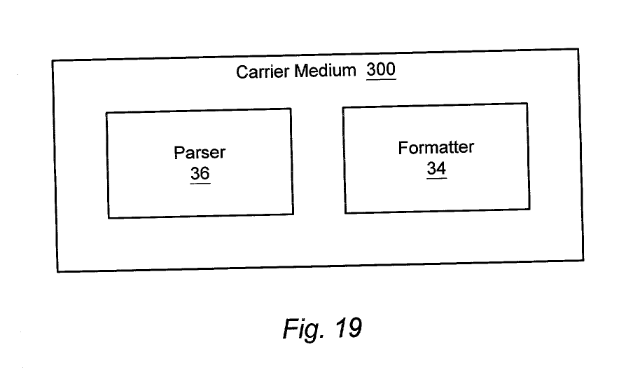

Turning next to FIG. 19, a block diagram of a carrier medium 300 is shown. Generally speaking, a carrier medium may include computer readable media such as storage media (which may include magnetic or optical media, e.g., disk or CD-ROM), volatile or non-volatile memory media such as RAM (e.g. SDRAM, RDRAM, SRAM, etc.), ROM, etc., as well as transmission media or signals such as electrical, electromagnetic, or digital signals, conveyed via a communication medium such as a network and/or a wireless link.

The carrier medium 300 is shown storing the parser 36 and the formatter 34. That is, the carrier medium 300 is storing instruction sequences corresponding to the parser 36 and the formatter 34. Other embodiments may store only one of the parser 36 or the formatter 34. Still further, other code sequences may be stored (e.g. the simulation control code 32, the socket 38, the test program 52, the hub control code 62, etc.).

The carrier medium 300 as illustrated in FIG. 19 may represent multiple carrier media in multiple computer systems on which the distributed simulation system 10 executes. For example, the simulation control code 32 may be on a carrier medium in a first computer system on which a given DSN executes, and the hub control code 62 may be on a different carrier medium in a second computer system on which the hub executes.

Numerous variations and modifications will become apparent to those skilled in the art once the above disclosure is fully appreciated. It is intended that the following claims be interpreted to embrace all such variations and modifications.

What is claimed is:

1. A distributed simulation system comprising:
a plurality of nodes, each node configured to simulate a model of a different portion of a system under test, wherein each portion of the system under test has one or more physical signals for communicating with other portions of the system under test, and wherein the plurality of nodes are configured to communicate using message packets, wherein the message packets are formatted according to a grammar which provides for abstracting communication between the nodes from physical signals to logical ports, wherein each logical port corresponds to one or more of the physical signals.

2. The distributed simulation system as recited in claim 1 wherein the grammar includes a first one or more commands defining the logical ports for the system under test.

3. The distributed simulation system as recited in claim 2 wherein the plurality of nodes are configured to use the definition from the first one or more commands to format and parse message packets containing signal information.

4. The distributed simulation system as recited in claim 2 wherein each logical port comprises at least one other logical port or logical signal, and includes zero or more other logical ports and zero or more logical signals.

5. The distributed simulation system as recited in claim 1 wherein the grammar includes a second one or more commands for each node, the second one or more commands defining a mapping of the physical signals to logical signals within the logical ports.

6. The distributed simulation system as recited in claim 5 wherein the nodes are configured to use the mapping to read physical signals for sending message packets and to modify physical signals in response to receiving message packets.

7. The distributed simulation system as recited in claim 5 wherein the second one or more commands include a mapping of one physical signal to two or more logical signals.

8. The distributed simulation system as recited in claim 5 wherein the second one or more commands include a mapping of one logical signal to two or more physical signals.

9. The distributed simulation system as recited in claim 1 wherein the grammar includes a third one or more commands defining one or more connections between logical ports from different ones of the plurality of nodes.

10. The distributed simulation system as recited in claim 9 further comprising a hub coupled to each of the plurality of nodes and configured to send message packets to the plurality of nodes and receive message packets from the plurality of nodes.

11. The distributed simulation system as recited in claim 10 wherein the hub is configured to use the definition from the third one or more commands to route message packets containing signal information from one of the plurality of nodes to another one of the plurality of nodes.

12. The distributed simulation system as recited in claim 1 wherein the message packets include control messages.

13. The distributed simulation system as recited in claim 12 wherein the control messages include a user message, and wherein an argument of the user message is a communication between a first program in a first node of the plurality of nodes and a second program in a second node of the plurality of nodes.

14. A carrier medium storing a sequence of instructions for execution in a distributed simulation system including a plurality of nodes, wherein the sequence of instructions, when executed, parses a message packet formatted according to a grammar which provides for abstracting from physical signals in the system under test to logical ports, each port corresponding to one or more of the physical signals.

15. The carrier medium as recited in claim 14, wherein the grammar includes a first one or more commands defining the logical ports for the system under test, and wherein the code sequence, when executed, processes the first one or more commands to create a data structure identifying the logical ports for parsing message packets.

16. The carrier medium as recited in claim 14 wherein the grammar includes a second one or more commands for each node, the second one or more commands defining a mapping of the physical signals to logical signals within the logical ports, wherein the code sequence, when executed, processes the second one or more commands to create the mapping.

17. The carrier medium as recited in claim 14 wherein the grammar includes a third one or more commands defining one or more connections between logical ports from different ones of the plurality of nodes, and wherein the code sequence, when executed, processes the third one or more commands for routing message packets containing signal information between the nodes.

18. A carrier medium storing a sequence of instructions for execution in a distributed simulation system including a plurality of nodes, wherein the sequence of instructions, when executed, formats a message packet according to a grammar which provides for abstracting from physical signals in the system under test to logical ports, each port corresponding to one or more of the physical signals.

19. The carrier medium as recited in claim 18, wherein the grammar includes a first one or more commands defining the logical ports for the system under test, and wherein the code sequence, when executed, formats the message packet using the logical ports if the message packet includes signal information.

20. The carrier medium as recited in claim 18 wherein the grammar includes a second one or more commands for each node, the second one or more commands defining a mapping of the physical signals to logical signals within the logical ports, wherein the code sequence, when executed, selects a first logical port corresponding to the physical signals to be transmitted if the message packet includes signal information, the first logical port selected for inclusion in the message packet.

21. In a distributed simulation system including a plurality of nodes, a method comprising:
formatting a message packet according to a grammar which provides for abstracting from physical signals in the system under test to logical ports, each port corresponding to one or more of the physical signals; and
parsing the message packet formatted according to the grammar.
